(19) United States
(12) Patent Application Publication
(10) Pub. No.: US 2015/0149497 A1
(43) Pub. Date: May 28, 2015

(54) DETERMINING PROBLEM RESOLUTIONS WITHIN A NETWORKED COMPUTING ENVIRONMENT

(71) Applicant: International Business Machines Corporation, Armonk, NY (US)

(72) Inventors: Rose C Kanjirathinkal, Bangalore (IN); Anindya Neogi, Pune (IN); Sriram Raghavan, Bangalore (IN)

(21) Appl. No.: 14/467,834

(22) Filed: Aug. 25, 2014

Related U.S. Application Data
(63) Continuation of application No. 14/092,030, filed on Nov. 27, 2013.

(51) Int. Cl. G06F 17/30

(52) U.S. Cl. CPC G06F 17/3053
USPC 707/765

(57) ABSTRACT

A method is provided for determining problem resolutions within a networked computing environment. The method includes retrieving, by one or more computer processors, event data from within a networked computing environment. The method includes determining, by the one or more computer processors, a characteristic of a database within the networked computing environment, the database storing a plurality of problem resolutions. The method includes determining, by the one or more computer processors, a search query corresponding to the event data and to the characteristic of the database. The method includes performing, by the one or more computer processors, a first search of the database using the search query and then refining, by the one or more computer processors, the search query. The method then includes performing, by the one or more computer processors, at least one additional search of the database using the refined search query.

Various aspects of the present invention have been disclosed by an inventor or a joint inventor generally to the public in the product IBM SmartCloud Analytics—Log Analysis V1.1.0.2, made publically available on Sep. 13, 2013. This disclosure is submitted under 35, U.S.C. 102(b)(1)(A). The following documentation is provided in support:
IBM SmartCloud Analytics—Log Analysis Service Management Download Page, including Version 1.1.0.2 Trial Version listing
IBM SmartCloud Analytics—Log Analysis, Version 1.1.0.2 User's Guide

### FIELD OF THE INVENTION

The present invention relates generally to the field of managing computer data, and more particularly to determining problem resolutions within a networked computing environment by searching for problem resolution entries in expert knowledge databases using event data.

### BACKGROUND OF THE INVENTION

Different components of an application running on a machine issue logs or event messages that document various events that were processed by the component and a time at which the event occurred. When a failure occurs in the application, the logs or event messages can provide information on what events occurred in each of the components that may have led to the failure. Once potential events have been identified, a solution must be determined. Solutions can come from expert knowledge, such as content in technology notes, a practitioner's experience write up, or online discussion forums. Solutions can include steps to resolve the failure, recover the application or any lost data, and to roll back database transactions.

### SUMMARY

Embodiments of the present invention disclose a method, computer program product, and computer system for determining problem resolutions within a networked computing environment. In an embodiment, a computer processor retrieves event data from within a networked computing environment. The computer processor determines a characteristic of a database within the networked computing environment, the database storing a plurality of problem resolutions. The computer processor determines a search query corresponding to the event data and to the characteristic of the database and then performs a first search of the database using the search query. The computer processor then refines the search query and performs at least one additional search of the database using the refined search query.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operational steps of a search program for retrieving event data, issuing search queries, and searching knowledge databases for event resolution, in accordance with an embodiment of the present invention.

FIG. 3 depicts an exemplary flow diagram of operation of the search program of FIG. 2, in accordance with an embodiment of the present invention.

FIG. 4 depicts a block diagram of components of a data processing system, such as the server computing device of FIG. 1, in accordance with an embodiment of the present invention.

### DETAILED DESCRIPTION

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module” or “system”. Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object-oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer-implemented process such that the instructions which execute on the computer or other programmable apparatus provide processes for implementing the functions/acts specified in the flowchart and/or block diagram block or blocks.

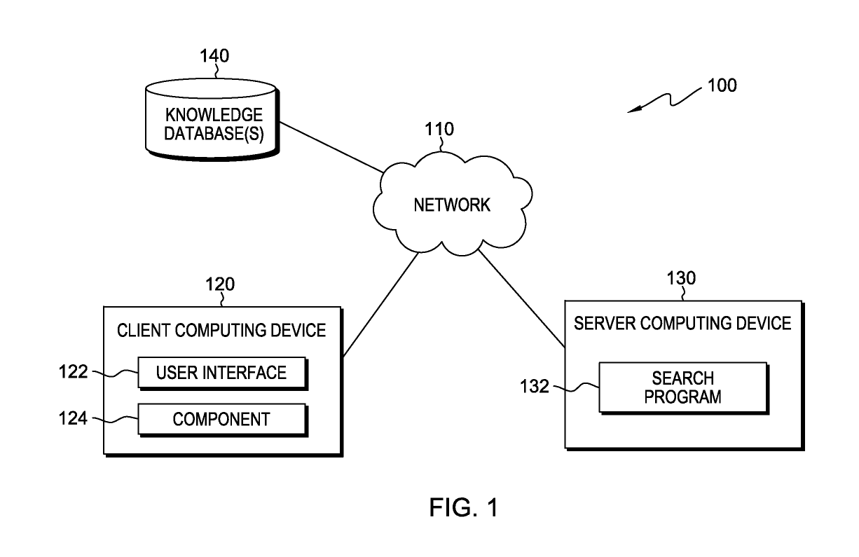

The present invention will now be described in detail with reference to the Figures. FIG. 1 is a functional block diagram illustrating a distributed data processing environment, generally designated 100, in accordance with one embodiment of the present invention. Distributed data processing environment 100 includes client computing device 120, server computing device 130, and knowledge database(s) 140, all interconnected over network 110. Network 110 may be a local area network (LAN), a wide area network (WAN), such as the Internet, any combination of the two, or any combination of connections and protocols that will support communication between client computing device 120, server computing device 130, and knowledge database(s) 140, in accordance with embodiments of the present invention. Network 110 may include wired, wireless, or fiber optic connections.

Client computing device 120 may be a laptop computer, a tablet computer, a netbook computer, a personal computer (PC), a personal digital assistant (PDA), a smart phone, or any programmable electronic device capable of communicating with server computing device 130 via network 110. Client computing device 120 may represent multiple computing devices capable of communicating with each other, and with server computing device 130, via network 110. Client computing device 120 includes user interface (UI) 122 and component 124. UI 122 may be, for example, a graphical user interface (GUI) or a web user interface (WUI) and can display documents, web browser windows, user options, instructions for operation, images, and other instruments containing data. Component 124 can be a computer software application, system software, computing platform, operating system, utility, programming tool, or any application running on client computing device 120 that includes different components that can document, for example, in a log, various events, and a time at which the events occurred, in order to provide information on what events transpired in each component leading up to a failure point.

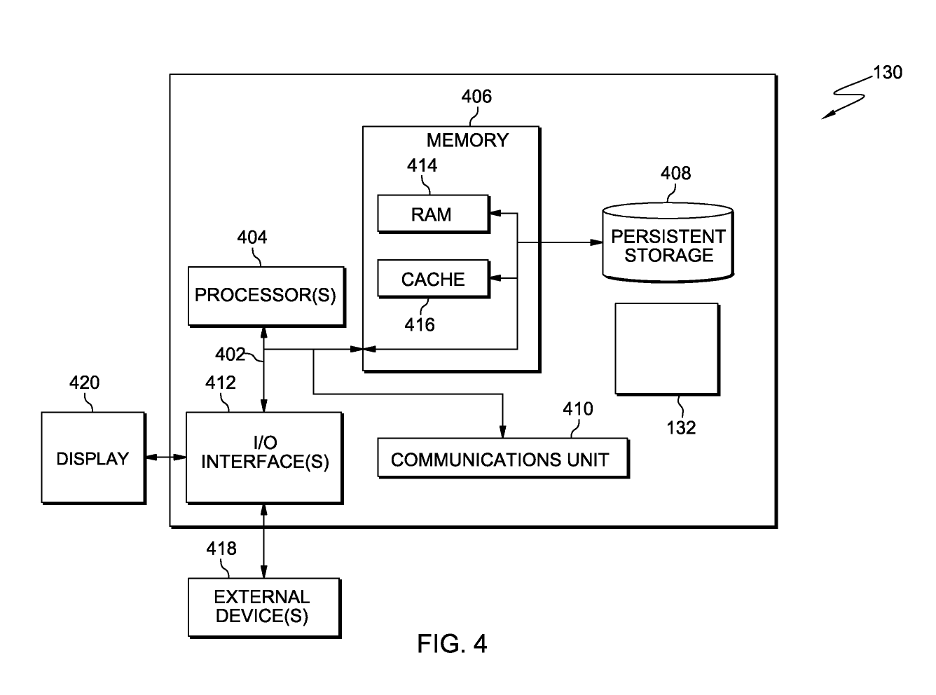

Server computing device 130 may be a laptop computer, a tablet computer, a netbook computer, a PC, a PDA, a smart phone, or any programmable electronic device capable of communicating with client computing device 120 and knowledge database(s) 140 via network 110. Server computing device 130 may be a management server, a web server, or may represent a computing system utilizing clustered computers and components to act as a single pool of seamless resources when accessed through a network. Server computing device 130 may include internal and external components, as depicted and described in further detail with respect to FIG. 4.

Server computing device 130 includes search program 132. Search program 132 receives log event data from within distributed data processing environment 100. Search program 132 then determines one or more keywords related to the log event data and determines characteristics of a database within distributed data processing environment 100, for example, knowledge database(s) 140. Knowledge database(s) 140 may include characteristics such as storing data in a structured format, for example, a structured database, or storing data in an unorganized manner, for example, as in unstructured databases. In an embodiment, search program 132 can search a structured database using a structured query and constraints associated with the structured query, such as context of the log event data. Search program 132 receives results of the search and ranks the results by relevance. If search program 132 does not obtain any results for the structured query issued, then it refines the query by relaxing one or more of the constraints. The refined query is then issued against knowledge database(s) 140. Search program 132 continues until a required number of results are obtained, or until search program 132 has exhausted all queries. Search program 132 then presents the results to a user within distributed data processing environment 100.

Knowledge database(s) 140 may represent one or multiple databases within distributed data processing environment 100. In an embodiment, one or more of the multiple databases can be structured databases. In an embodiment, one or more of the multiple databases can be unstructured databases. In yet another embodiment, knowledge database(s) 140 can be either structured or unstructured or both. Search program 132 determines characteristics of knowledge database(s) 140, for example, whether knowledge database(s) 140 is structured or unstructured, containing, respectively, structured data or unstructured data. A structured database stores information in an organized, pre-defined manner, and the data stored is identifiable because if is organized in a structure. An unstructured database stores information without an organized, pre-defined manner and has no identifiable structure. In an exemplary embodiment of the present invention, knowledge database(s) 140 stores potential problem and event resolutions and problem descriptions for log event data within distributed data processing environment 100. While in FIG. 1, knowledge database(s) 140 is shown separate from client computing device 120 and server computing device 130, in various other embodiments, knowledge database(s) 140 may be located within either client computing device 120 or server computing device 130, accessible by search program 132 via network 110.

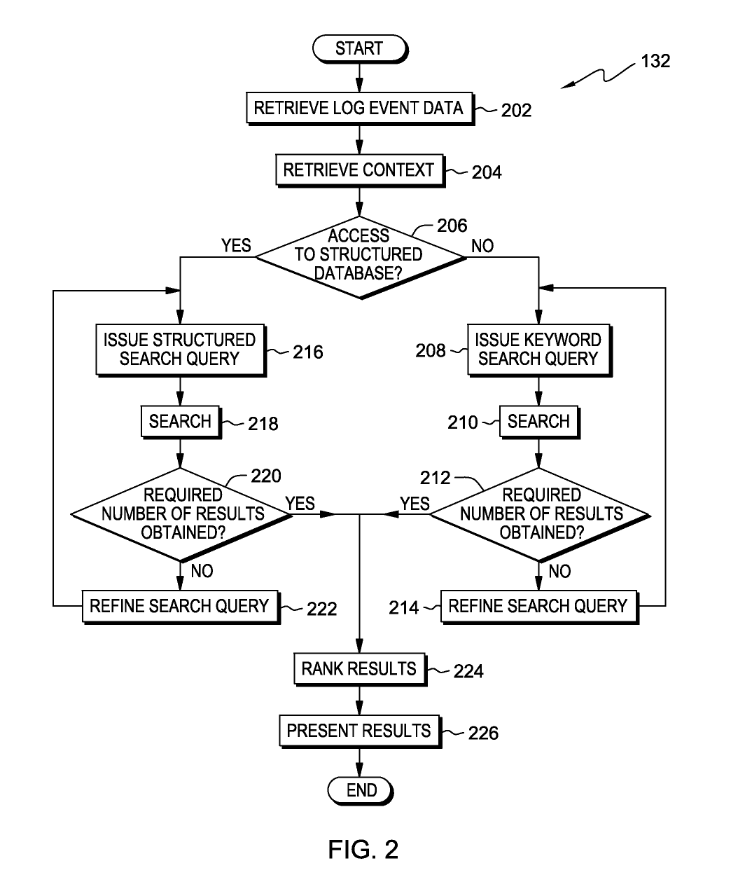

FIG. 2 is a flowchart depicting operational steps of search program 132 for retrieving event data, issuing search queries, and searching knowledge databases for event resolution, in accordance with an embodiment of the present invention.

Search program 132 retrieves log event data (step 202). For example, components of different applications, including hardware and software applications, running on a computing machine document events, including events that are processed by the component and the time at which the events occurred. The log event data can include event messages, message ids or text, as well as other identifying information. Components can be, for example, a server either hosting the application or hosting the backend of the application. Components may also be system logs of machines on which the servers are installed. In distributed data processing environment 100, for example, component 124 on client computing device 120 can issue log event data containing information reflective of the events leading up to a failure. Failures can occur within component 124, or external thereto via another component or application connected to component 124 that transmits data to or is accessed by component 124.

Search program 132 retrieves context associated with the log event data (step 204). Context can include, for the relevant components within distributed data processing environment 100 (e.g., components documents events and issuing log event data), topology information, configuration of the components of the application, a set of events that happened in a certain time frame, or a search for problem resolutions, if any, performed by the user and results of the search. Received log event data context can be accessed on the computing device on which the components reside, for example, client computing device 120, or, alternatively, context may be maintained elsewhere within distributed data processing environment 100 accessible via network 110.

Search program 132 determines if there is access to a structured database (decision block 206). Search program 132 determines characteristics of knowledge database(s) 140, for example, whether knowledge database(s) 140 contain structured or unstructured data. A structured database, or knowledge database, can support a structured querying mechanism where different constraints can be specified by pre-defined constructs. For example, a structured knowledge database may be an IBM DB2® database, and a sample query issued may be a Structured Query Language (SQL) statement of the form, “SELECT T.Resolution FROM TechNoteTable T WHERE CONTAINS (T.ProblemDescription, ‘connection error’)=1 AND T.OperatingSystem=‘AIX’ AND T.Version=‘1.7’”. In the example, information from retrieved log event data is added to the predefined constructs such as “SELECT”, “FROM”, and “WHERE CONTAINS”, and the structured query is used against a structured database. The structured database may contain data organized by field, whereby information in the “SELECT” field of the search query is searched against a first data, while information in the “WHERE CONTAINS” field is searched against a second data. An unstructured knowledge database, however, does not support any structured querying mechanism, instead it accepts queries as a set of terms called “keywords”. For example, an unstructured knowledge database may be the IBM Support Portal site, and a sample query issued may be of the form, “connection error AIX 1.7”. Knowledge database(s) 140 can be either structured or unstructured, as described above with reference to FIG. 1. In an exemplary embodiment of the present invention, knowledge database(s) 140 stores problem resolutions and problem descriptions for log event data within distributed data processing environment 100.

If there is no access to a structured database (decision block 206, “no” branch), search program 132 issues a keyword search query (step 208). Search program 132 can extract keywords from the retrieved log event data and context; for example, a log event may contain keywords such as “memory” and “connection pool”, and the context may indicate the log event was generated by a “WebSphere Application Server”. Search program 132 may determine the search query for the corresponding log event data and context as one or more of the keywords, such as “memory and WebSphere Application Server”.

Search program 132 performs a search of information stored in unstructured knowledge database 140 (step 210). For example, search program 132 searches the information stored in knowledge database(s) 140 using the extracted keywords to find any documents or information that contains all of the keywords.

Search program 132 determines whether a required number of results are obtained (decision block 212). A required number of results may be determined by a user or by a configuration parameter, such as “return ten results per search”. If the required number of keyword search query results have been obtained (decision block 212, “yes” branch), search program 132 proceeds to rank the results (step 224). If the required number of keyword search query results are not obtained (decision block 212, “no” branch), search program 132 refines the keyword search query (step 214). Search program 132 refines the keyword search query by revising the keywords used. Search program 132 removes keywords from the search query to further generate results; for example, a second keyword search query may use only “websphere” or “connection pool”. Search program 132 then issues the refined keyword search query against unstructured knowledge database(s) 140 (step 208) and performs an additional search using the refined keyword search query. Search program 132 continues until the required number of results is obtained. In an embodiment, search program 132 continues until all combinations and variations of keyword search queries are exhausted.

If there is access to a structured database (decision block 206, “yes” branch), search program 132 issues a structured search query (step 216) and searches structured knowledge database(s) 140 (step 218). An initial structured search query may include using the retrieved context against structured knowledge database(s) 140 to determine whether there is a match with data in knowledge database(s) 140. In an exemplary embodiment of the present invention, search program 132 can determine a structured search query for a search of knowledge database(s) 140 that contains topology information or configuration parameters in order to locate the appropriate set of documents or information for the search.

Search program 132 determines whether a required number of results are obtained (decision block 220). A required number of results may be determined by a user or by a configuration parameter of the system. If the required number of results are obtained (decision block 220, “yes” branch), search program 132 ranks the results (step 224). If the required number of results are not obtained (decision block 220, “no” branch), search program 132 refines the structured search query by relaxing a set of constraints, for example, by removing one or more constraints (step 222).

In an embodiment of the present invention, if an exact match to context, such as a configuration parameter, cannot be found, search program 132 can apply one or more constraints to the search query. Constraints may be, for example, a requisiteness score, a compatibility score, or keywords, and the search query may be refined by removing words or constraints from the search query. In an embodiment, search program 132 can access a requisiteness score, which provides a measure of how critical it is to match a configuration parameter. In an embodiment of the present invention, the requisiteness score can have a range of “0” to “1”, with “0” being the least and “1” being the most mandatory. For example, a match for “operating system family” might have a requisiteness score of “1”, indicating that a solution for Windows cannot be applied to a Mac and that it is mandatory that a match be found in knowledge database(s) 140 for a Mac operating system. A refined structured search query may also include dropping one or more of the context constraints according to the requisiteness score of the constraint; for example, if there is no match for the “operating system family”, and the requisiteness score is “0”, then the “operating system family” constraint can be dropped. A requisiteness score for each configuration parameter may be manually specified as an input to search program 132 by a user, a subject matter expert, a domain expert, or the requisiteness score may be learned by analyzing text of a problem-resolution entry or the event data.

In another embodiment of the present invention, if an exact match cannot be found in knowledge database(s) 140, search program 132 may have access to a taxonomy of the configuration parameters. A taxonomy of a configuration parameter provides the compatibility of each possible value of the configuration parameter, along with a compatibility score. For example, for the configuration parameter “operating system” or “OS”, two possible values are Mac OS® and Windows® OS, however, the taxonomy of the configuration parameter provides that the two OS are not compatible with each other. Mac OS® is a trademark of Apple Inc., registered in the U.S. and other countries. Windows® is a registered trademark of the Microsoft Corporation in the United States and other countries. No Mac OS® would have a parent-child relationship with a Windows® OS, or vice versa. However, Mac OS X Snow Leopard and Mountain Lion may share a parent-child or a common ancestor relationship with a compatibility score closer to “1”. If search program 132 finds no exact match for a particular configuration when searching in knowledge database(s) 140, the system accesses the taxonomy of that configuration parameter to check if the parameter values in knowledge database(s) 140 and the log event data entry are compatible. If the two values do not have a parent-child relationship in the taxonomy tree, search program 132 can use the distance between the two values in the tree to determine a compatibility score between the two parameter values. A refined structured search query may include replacing one or more of the context constraints with another context according to the compatibility score. For example, if there is no match in structured knowledge database(s) 140 for “OS=Windows 8”, the refined structured search query may replace “Windows 8” with “Windows” or another version of the OS. Search program 132 can perform an additional search of knowledge database(s) 140 using the refined structured search query. The taxonomy and the compatibility scores may be manually specified by a user, a subject matter expert, a domain expert, or may be automatically computer using a versions database.

In another embodiment, the structured search query may be refined by removing keywords from the search to generate further results, as in the keyword search against unstructured knowledge database(s) 140.

Search program 132 ranks the results (step 224). In an embodiment, results from all searches of knowledge database(s) 140, for example, problem resolutions for retrieved log event data and context, can be merged and ranked together. In various embodiments of the present invention, ranking of results can take into account the reliability of a source for the result problem resolution, a preciseness of the search query used to obtain the result problem resolution, a match between the event data and a failure associated with the result problem resolution, a context match between the event data and the failure associated with the result problem resolution, and a confidence and quality of the result obtained. In an exemplary embodiment of the present invention, search program 132 can use the requisiteness score of the configuration parameter and the matching log event entry to sort results by their order of relevance, or search program 132 can use the compatibility score for each configuration parameter and sort the results in order of relevance.

Search program 132 presents results (step 226). For example, search program 132 obtains results from either a structured database, unstructured database, or both, and presents the results to a user, for example, a user operating on client computing device 120 in distributed data processing environment 100. The results may be presented in a list format.

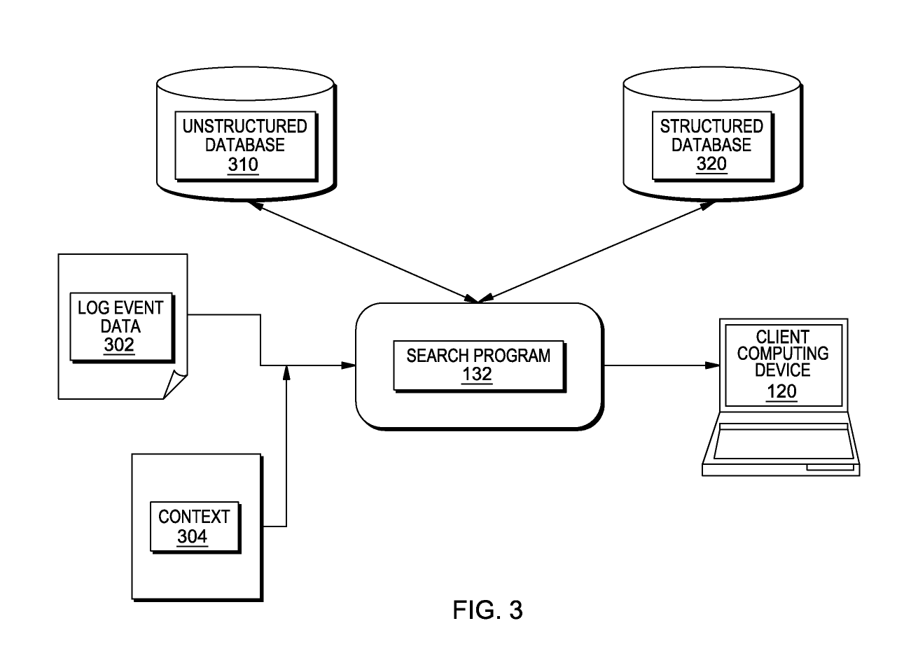

FIG. 3 depicts an exemplary flow diagram of operation of search program 132, in accordance with an embodiment of the present invention.

The flow diagram depicted in FIG. 3 includes input of log event data 302 and context 304 into search program 132. Search program 132 communicates with unstructured database 310 and structured database 320 to obtain results by issuing keyword search queries and structured search queries, respectively, against each database. Search program 320 then presents the results on client computing device 120.

FIG. 4 depicts a block diagram of components of server computing device 130 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Server computing device 130 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Search program 1320 is stored in persistent storage 408 for execution by one or more of the respective computer processor(s) 404 via one or more memories of memory 406. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including client computing device 120 and knowledge database(s) 140. In these examples, communications unit 410 includes one or more network interface cards. Communications unit 410 may provide communications through the use of either or both physical and wireless communications links. Search program 132 may be downloaded to persistent storage 408 through communications unit 410.

I/O interface(s) 412 allows for input and output of data with other devices that may be connected to server computing device 130. For example, I/O interface(s) 412 may provide a connection to external device(s) 418 such as a keyboard, a keypad, a touch screen, and/or some other suitable input device. External device(s) 418 can also include portable computer-readable storage media such as, for example, thumb drives, portable optical or magnetic disks, and memory cards. Software and data used to practice embodiments of the present invention, e.g., search program 132, can be stored on such portable computer-readable storage media and can be loaded onto persistent storage 408 via I/O interface(s) 412. I/O interface(s) 412 also connect to a display 420. Display 420 provides a mechanism to display data to a user and may be, for example, a computer monitor or an incorporated display screen, such as is used in tablet computers and smart phones.

The programs described herein are identified based upon the application for which they are implemented in a specific embodiment of the invention. However, it should be appreciated that any particular program nomenclature herein is used merely for convenience, and thus, the invention should not be limited to use solely in any specific application identified and/or implied by such nomenclature.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for determining problem resolutions within a networked computing environment, the method comprising:
retrieving, by one or more computer processors, event data from within a networked computing environment;
determining, by the one or more computer processors, a characteristic of a database within the networked computing environment, the database storing a plurality of problem resolutions;
determining, by the one or more computer processors, a search query corresponding to the event data and to the characteristic of the database;
performing, by the one or more computer processors, a first search of the database using the search query;
refining, by the one or more computer processors, the search query; and
performing, by the one or more computer processors, at least one additional search of the database using the refined search query.

2. The method of claim 1, further comprising:
receiving, by one or more computer processors, results from the first search and the at least one additional search of the database, the results including one or more of the plurality of problem resolutions;
ranking, by the one or more computer processors, the results; and
presenting, by the one or more computer processors, the results.

3. The method of claim 1, wherein determining, by the one or more computer processors, a search query corresponding to the event data and to the characteristic of the database further comprises:
determining, by the one or more computer processors, the characteristic of the database is unstructured data;
responsive to determining the characteristic of the database is unstructured data, determining, by the one or more computer processors, at least one keyword of the event data; and
issuing, by the one or more computer processors, the at least one keyword of the event data as the determined search query.

4. The method of claim 1, wherein determining, by the one or more computer processors, a search query corresponding to the event data and to the characteristic of the database further comprises:
determining, by the one or more computer processors, the characteristic of the database is structured data;
responsive to determining the characteristic of the database is structured data, retrieving, by the one or more computer processors, a context associated with the event data; and
issuing, by the one or more computer processors, the context associated with the event data as the determined search query.

5. The method of claim 1, wherein refining, by one or more computer processors, the search query, further comprises:
determining, by one or more computer processors, at least a first constraint and a second constraint; and
applying, by one or more computer processors, the at least first constraint and the second constraint to the search query.

6. The method of claim 5, further comprising:
removing, by the one or more computer processors, one of the at least first constraint and the at least second constraint from the search query.

7. The method of claim 1, wherein refining, by one or more computer processors, the search query, further comprises:
determining, by the one or more computer processors, the search query includes two or more words;
removing, by the one or more computer processors, from the search query, at least one of the two or more keywords; and
issuing, by the one or more computer processors, a second search query comprising the search query without the removed at least one of the two or more keywords.
